(19) United States
(12) Patent Application Publication
(10) Pub. No.: US 2002/0186428 A1
(43) Pub. Date: Dec. 12, 2002

(54) Crosstalk path enumeration in optical networks

(76) Inventor: Hasan I. Saleheen, Painted Post, NY (US)

Correspondence Address: CORNING INCORPORATED, SP-TI-3-1, CORNING, NY, 14831

(21) Appl. No.: 09/878,090

(22) Filed: Jun. 8, 2001

(51) Int. Cl. H04B 10/08; H04K 3/00

(52) U.S. Cl. 359/110; 359/111

(57) ABSTRACT

A method for monitoring crosstalk in an optical network having a plurality of optical devices. Initially, crosstalk is determined at a first optical device in the optical network. The crosstalk is expressed by a plurality of crosstalk terms. The most prominent crosstalk term is then identified from the plurality of crosstalk terms associated with the first optical device. Next, crosstalk is determined at a second optical device in the optical network. Likewise, the crosstalk is expressed by a plurality of crosstalk terms. The most prominent crosstalk term is also identified from the plurality of crosstalk terms associated with the second optical device. Then, a path exhibiting traversal of crosstalk in the optical network is enumerated in association with the most prominent crosstalk terms from the first and/or second optical device.

### BACKGROUND OF THE INVENTION

1. Field of the Invention

The present invention relates generally to methods for analyzing predicting, monitoring, and managing impairments in optical networks, and more particularly, to methods for analyzing and predicting and/or monitoring crosstalk in large multiwavelength optical networks by enumerating paths and associated crosstalk terms in optical networks.

2. Technical Background

With recent commercialization of multiwavelength optical networking, wavelength division multiplexing (WDM) provides viable solutions to rapidly increasing demands for voice, video and data communication requirements. As more WDM networks are deployed in metropolitan areas, maintaining the proper level of quality of service (QoS) is becoming a major issue for network service providers due to impairments arising from the large number of network components. Some major performance-degrading impairments that may arise within an optical network include polarization-dependent loss, polarization-mode dispersion, chromatic dispersion, signal distortion due to filtering, reflection, etc. One of the most significant transmission impairments affecting QoS in the metropolitan networks is crosstalk between signal channels.

Crosstalk is the interference between different optical signals, and is mostly due to the imperfect filtering and switching in network elements that induce signals to leak from one channel to the others. Optical crosstalk can lead to error floors and impose severe requirements on the network components, thereby contributing to significant network performance degradation. In general, an optical network includes a large number of network elements such as demultiplexer (DEMUX), add-drop multiplexer (ADM), optical cross-connect (OXC), etc. These network elements are particularly susceptible to crosstalk in the metropolitan optical networks because signal traffic may undergo frequent routing and/or add-drop operations. Accordingly, it is more likely that the dominant crosstalk in the metropolitan networks arises from such network elements rather than from transmission fibers.

Crosstalk terms are generated from different networking elements as signals traverse through them due to imperfect filtering and switching functions. Additional crosstalk terms are generated as signals repeatedly traverse through the network elements. Thus, the number of crosstalk term can very easily reach to a prohibitively high number. In many cases, a small number of prominent crosstalk terms dictate the performance of the overall system. These prominent crosstalk terms may have a significant effect on the reliability of the system.

Some simulation tools have been developed to evaluate the effects of various impairments (including crosstalk) in point-to-point systems and networks. Such products include Wavelength Domain Simulator (WDS) developed by Telcordia Technologies, Photonics Transmission Design Suite (PTDS) developed by Virtual Photonics (http://www.virtualphotonics.com) and OptSim developed by Artis Software (http://www.artis.it). However, despite any differences in implementation, the computation time required by most of these simulation tools makes them impractical for simulating large multiwavelength optical networks.

### SUMMARY OF THE INVENTION

The present invention provides a method that identifies the network devices that create the most significant crosstalk effects in the network so that system performance can be optimized more efficiently. Thus, the dominant network impairments can be optimized more efficiently. Thus, the dominant network impairments in a metropolitan optical network can be tracked, predicted, and/or monitored in a way that allows simulation to be performed quickly and efficiently, even for large multiwavelength optical networks.

In accordance with the teachings of the present invention, a method is provided for monitoring crosstalk in an optical network having a plurality of optical devices. Initially, crosstalk is determined at a first optical device in the optical network. The crosstalk is expressed by a plurality of crosstalk terms. One or more of the most prominent crosstalk terms are then identified from the plurality of crosstalk terms associated with the first optical device. Next, crosstalk is determined at a second optical device in the optical network. Likewise, the crosstalk associated with the second optical device is expressed by a plurality of crosstalk terms. One or more of the most prominent cross talk terms are also identified from the plurality of crosstalk terms associated with the second optical device. A path associated with the most prominent crosstalk term of the first and second optical devices is then enumerated in the optical network. The same procedure can be applied for enumerating the paths associated with one or multiple crosstalk terms.

It is to be understood that both the foregoing general description and the following detailed description are merely exemplary of the invention, and are intended to provide an overview or framework for understanding the nature and character of the invention as it is claimed. The accompanying drawings are included to provide a further understanding of the invention, and are incorporated in and constitute a part of this specification. The drawings illustrate various features and embodiments of the invention, and together with the description serve to explain the principles and operation of the invention.

### BRIEF DESCRIPTION OF THE DRAWINGS

Additional objects, advantages and features of the present invention will become apparent to one skilled in the art by reading the following specification and appended claims, and by referencing the following drawings in which:

FIG. 1 is a flowchart depicting a method for monitoring crosstalk in an optical network, according to the present invention;

FIG. 2 is a diagram depicting a preferred format for an enumerated path which exhibits traversal of crosstalk in an optical network in accordance with the present invention;

FIG. 3 is a schematic representation of two concatenated network elements within a portion of an exemplary optical network, according to the present invention; and

FIG. 4 is a schematic representation of a wavelength-selective cross-connect (WSXC) in a portion of an exemplary optical network, according to the present invention.

### DETAILED DESCRIPTION OF THE PREFERRED EMBODIMENTS

Reference will now be made in detail to the presently preferred embodiments of the invention, examples of which are illustrated in the accompanying drawings. Whenever possible, the same reference numerals will be used throughout the drawings to refer to the same or like parts.

A method for monitoring crosstalk in an optical network having a plurality of devices is provided in accordance with the present invention. In general, a crosstalk level represented by an optical crosstalk term is calculated in a block-by-block basis for all channels in an optical network. An enumerated (i.e., a labeled) path is then identified for each crosstalk term. More specifically, the crosstalk level and the enumerated path are determined from each one of the input ports to each one of the output ports of every network device in the optical network.

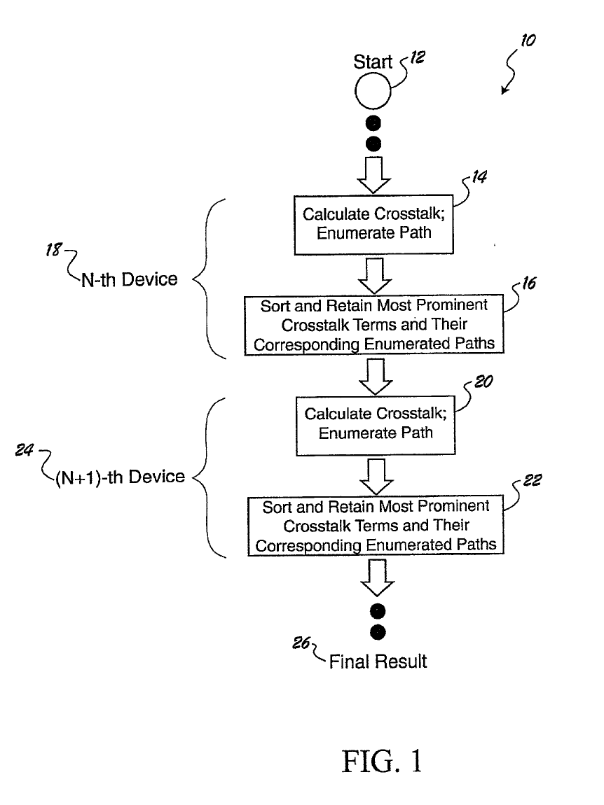

Referring to FIG. 1, the crosstalk terms are calculated for each channel of the N-th device 18 at step 14. The method for calculating crosstalk is well known to those skilled in the art as disclosed in the article entitled “Wavelength Domain Simulation in Multiwavelength Optical Networks”, IEEE Journal of Selected Topics in Quantum Electronics, vol.6, No. 2, published March/April, 2000, and incorporated herein by reference. The present invention calculates the crosstalk level using a port-to-port transfer function of each channel based on the method disclosed by this article. However, it should be understood that other methods for calculating the crosstalk level may also be used. Crosstalk levels may also be determined for network devices which do not generate crosstalk (i.e. variable optical attenuater (VOAs)) as is known in the art.

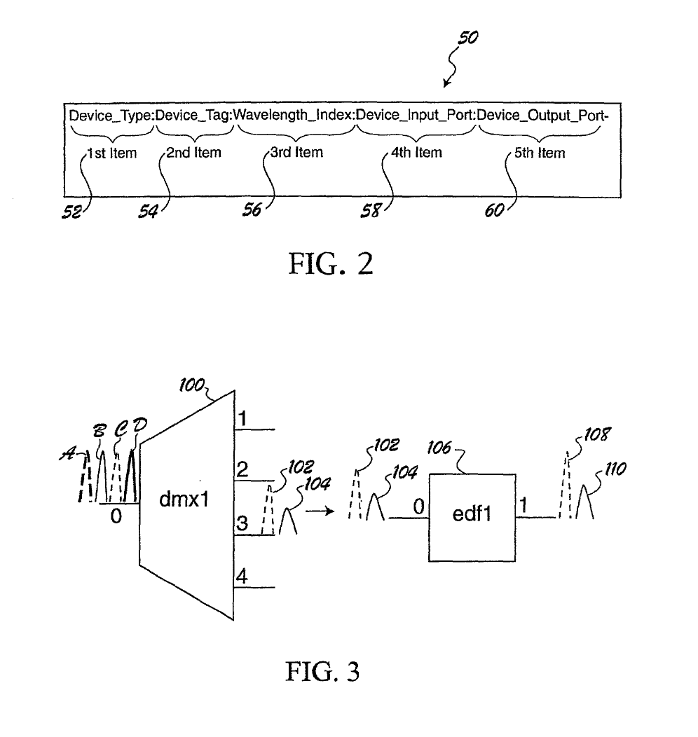

A device path corresponding to each of the crosstalk terms is also identified at step 14. The device path of each crosstalk term is denoted in a standardized data format, such as the format 50 shown in FIG. 2. The first item 52 specifies the type of the network device at which the crosstalk is occurring. For example, the first item 52 may be a demultiplexer (DEMUX), a multiplexer (MUX), a add-drop switch, a cross-connect switch, etc. A second item 54 specifies a network address for the device. Each device in an optical network is individually tagged with its own unique address within the network. A third item 56 specifies an index of the channel generating the crosstalk. Each channel is indexed to identify the source of the crosstalk term. Fourth and fifth items 58 and 60 represent input and output ports, respectively, associated with each crosstalk term. In this way, the fourth and fifth items 58 and 60 identify the physical path associated with crosstalk terms within the network device. Each item of information in the device path may be separated by a colon as shown in FIG. 2.

Referring back to FIG. 1, all contributing crosstalk terms for a given signal channel are sorted at step 16. For each channel, a predetermined number of crosstalk terms representing the strongest level of crosstalk are then selected. The enumerated device paths for the selected crosstalk terms associated with a given channel of the N-th device 18 are retained for further processing at step 16. The remainder of the crosstalk terms associated with the given channel of the N-th device 18 may be either discarded or stored for subsequent statistical analysis. These steps are performed, desirably in iterative fashion, for all channels traversing through the N-th device 18.

Next, the (N+1)-th device 24 is evaluated at steps 20 and 22. First, crosstalk associated with the (N+1)-th device 24 is determined and expressed as crosstalk terms. The crosstalk in the (N+1)-th device 24 may arise in part due to the previously generated crosstalk from the N-th device 18 and/or the leaking of signals traversing in and out of the device from the other adjacent channels. The crosstalk level associated with each crosstalk term is calculated at step 20 in the same manner described above. A device path for each crosstalk term associated with the (N+1)-th device 24 is also enumerated at step 20. More specifically, the device path of each crosstalk term associated with the (N+1)-th device 24 is enumerated using the format 50 shown in FIG. 2.

Also at step 20, a network path is enumerated in association with each device path at the (N=1)-th device so as to identify the traversal of the most significant crosstalk within the optical network. For a crosstalk term arising from crosstalk generated in the N-th device 18, the device path of the (N+1)-th device 24 is concatenated with the device path of the N-th device 18, which is the source of the crosstalk term. Each device path is associated with the device path of its adjacent devices from which the significant crosstalk term originated. It should be understood that the enumerated path of the crosstalk term, which is not originated from its previous device, is not concatenated with the enumerated path of its previous device.

Lastly, in step 22 each of the crosstalk terms identified at step 20 is sorted with respect to the other crosstalk terms associated with the same channel. A predetermined number of crosstalk terms having the strongest level of crosstalk associated with each channel of the (N+1)-th device 24 are selected. The corresponding enumerated network paths are retained at step 22 for further processing. The preferred embodiment of the present invention envisions that the portion of step 20 of enumerating the network path is performed in conjunction with step 22 of identifying the most prominent crosstalk terms. However, it should be understood that the step of identifying the most prominent crosstalk terms may be performed prior to the step of enumerating the network path. The above-described procedure for determining the most prominent crosstalk terms and their paths are performed on all of the network devices from one end to the other end of the network.

In FIG. 3, the method for monitoring crosstalk is described with reference to an optical network having two concatenated devices, a demultiplexer (DEMUX) 100 and an erbium-doped fiber amplifier (EDFA) 106. For purposes of the following description, the DEMUX 100 and the EDFA 106 are assumed network addresses of dmx1 and edf1, respectively. The DEMUX 100 receives a signal carrying four different channels: A, B, C and D. The DEMUX 100 then outputs four different signals carrying each of the channels through four different output ports 1, 2, 3 and 4, respectively, as denoted in FIG. 3. At each output port, each output signal may also carry crosstalk terms generated by the other channels.

Referring specifically to the output port 3 of the DEMUX 100, the output signal at the output port 3 carries its intended channel C and at least one crosstalk term. The crosstalk terms may occur due to the leaking of the other signals carrying channels A, B and D. When it is assumed that all of these crosstalk terms occur at the output port 3, the paths associated with these crosstalk terms are enumerated and represented using the format shown in FIG. 2. The crosstalk term created by the signal carrying channel A at the output port 3 has an enumerated device path denoted as DEMUX:dmx1:A:0:3. The crosstalk terms created by the signals carrying channels B and D at the output port 3 have the enumerated device paths denoted as DEMUX:dmx1:B:0:3 and DEMUX:dmx1:D:0:3, respectively.

The crosstalk levels of these three crosstalk terms are compared with each other. A predetermined number of the crosstalk terms having the strongest crosstalk levels are retained for further processing. The rest of the crosstalk terms may either be saved for a statistical analysis or discarded. In the example of FIG. 3, the single most prominent crosstalk term with the device path of DEMUX:dmx1:B:0:3 is selected for further processing. The other two crosstalk terms DEMUX:dmx1:A:0:3 and DEMUX:dmx1:D:0:3 are discarded. The output signal from output port 3 is represented with waveforms of two channels with different amplitudes. The intended channel 102 has the highest amplitude. The amplitude of a most prominent crosstalk term 104 is substantially less than that of the intended channel 102. Although it is not shown in FIG. 3, it should be understood that all crosstalk terms associated with each channel are determined using the input-to-output port transfer function of that channel. A predetermined number of the most prominent crosstalk terms associated with each channel are then selected for further processing in the same manner.

The output signal from output port 3 of the DEMUX 100 is transmitted to an input port 0 of the EDFA 106. Since the EDFA 106 is a non-crosstalk generating device, the output signal and crosstalk levels 108 and 110 are determined only by the input-to-output port transfer function of the EDFA 106. As illustrated in FIG. 3, the output signal having the intended channel wavelength 108 and the most prominent crosstalk term 110 is amplified by the EDFA 106. However, no additional crosstalk terms are created at output port 1 of the EDFA 106. The enumerated device path of the most prominent crosstalk term at the output port 1 of the EDFA 106 is denoted as EDFA:edf1:B:0:1. Accordingly, the network path determined at the output port 1 of the EDFA 106 is represented as DEMUX:dmx1:B:0:3-EDFA:edf1:B:0:1. The paths of the concatenated devices are hyphenated to indicate the links. In this way, the enumerated path, or the network path, represents the sources of the most prominent crosstalk terms and their routes in the optical network.

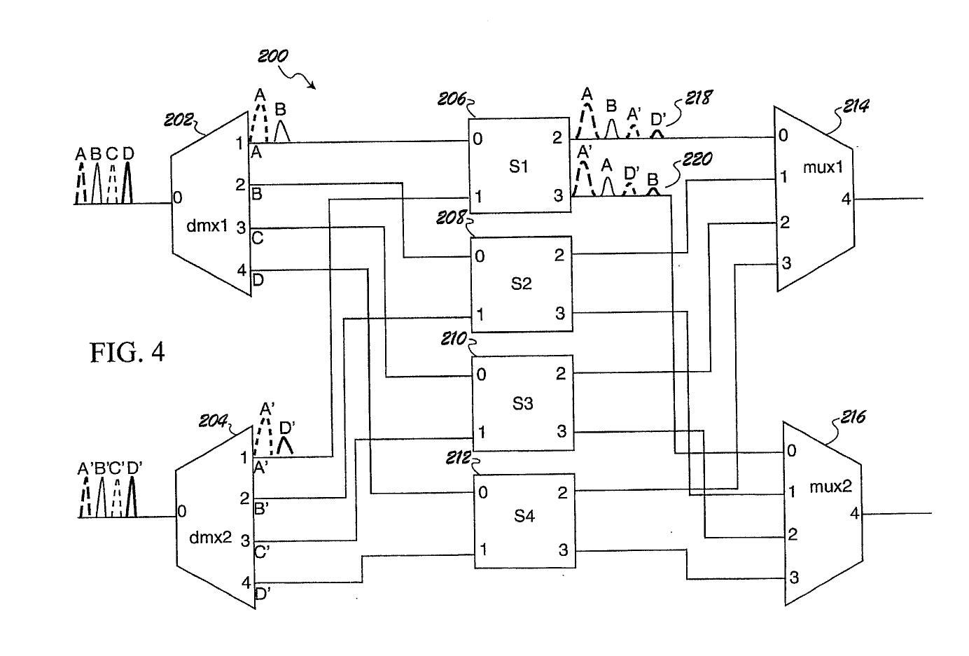

The method for monitoring crosstalk in another optical network is described with reference to FIG. 4. FIG. 4 illustrates a wavelength-selective cross-connect (WSXC) 200, which includes first (202) and second (204) DEMUXs. The first and second DEMUXs 202 and 204 are denoted as dmx1 and dmx2, respectively. Each of the DEMUXs 202 and 204 receives an input signal carrying four channels A-D and A′-D′, respectively. The first DEMUX 202 outputs four signals carrying each of the four channels A-D from its respective output ports 1-4. The second DEMUX 204 also outputs four signals carrying each of the four channels A′-D′ from its respective output ports 1-4.

The WSXC 200 also includes four 2×2 switches 206-212 denoted as S1, S2, S3 and S4, respectively, which receive input signals from the first (202) and second (204) DEMUXs. More specifically, a first input port 0 of the first switch (S1) 206 is connected to an output port 1 of the first DEMUX 202; whereas a second input port 1 of the first switch 206 is connected to an output port 1 of the second DEMUX 204. Input ports 0 and 1 of a second switch (S2) 208 are connected to an output port 2 of the first DEMUX 202 and an output port 2 of the second DEMUX 204, respectively. Input ports 0 and 1 of a third switch (S3) 210 and a fourth switch (S4) 212 are connected to the respective output ports of the first and second DEMUXs 202 and 204 in the same manner. As will be apparent to one skilled in the art, a 2×2 switch operates in either bar state or cross state. In the bar state, the signal flowing through the input port 0 exits through the output port 2. Likewise, the signal entering through the input port 1 exits through the output port 3. In the cross state, the signal flowing through the input port 0 exits through the output port 3. The signal, which enters through the input port 1, exits through the output port 2.

The WSXC 200 further includes first (214) and second (216) MUXs which are denoted as mux1 and mux2, respectively. Each of the first and second MUXs 214 and 216 includes one output port 4 and four input ports 0, 1, 2, and 3. The input ports 0-3 of the first MUX 214 are connected to the output ports 2 of the first to fourth switches 206-212 respectively, as shown in FIG. 4. The first MUX 214 outputs its output signal through the output port 4. The input ports 0-3 of the second MUX 216 are connected to the output ports 3 of the first to fourth switches 206-212 in the same manner. The second MUX 216 outputs its output signal through the output port 4.

The method for monitoring crosstalk in an optical network is described with particular reference to the signals and crosstalk terms associated with the first switch 206 of the WSXC 200. First, the process for identifying the most prominent crosstalk terms is performed on the first (202) and second (204) DEMUXs. For illustration purposes, it is presumed that the output signal from the output port 1 of the first DEMUX 202 is intended to carry channel A. The most prominent crosstalk term associated with the output signal at the output port 1 is assumed to occur due to channel B. Thus, the enumerated path of the most prominent crosstalk term at the output port 1 of the first DEMUX 202 is represented as DEMUX:dmx1:B:0:1. It is also presumed that the output signal from the output port 1 of the second DEMUX 204 is intended to carry channel A′. The most prominent crosstalk term associated with the output signal from output port 1 is assumed to occur due to channel D′. Thus, the enumerated path associated the most prominent crosstalk term at the output port 1 of the second DEMUX 204 is denoted as DEMUX:dmx2:D′:0:1.

The first switch 206 receives at its input port 0 the output signal from the output port 1 of the first DEMUX 202. Likewise, the first switch 206 receives at its input port 1 the output signal from the output port 1 of the second DEMUX 204. In the bar state, the output port 2 of the first switch 206 transmits the signal received from its input port 0. In this case, the signal at the output port 2 of the first switch 206 carries its intended channel A and the most prominent crosstalk term generated by channel B. The device path of the crosstalk term occurring due to channel B transmitted through the first switch 206 is denoted as SW:S1:B:0:2. Crosstalk may also occur due to the leaking of the signal entering through the input port 1. Thus, at the output port 2 of the first switch 206, two additional crosstalk terms may be generated by channels A′ and D′ as shown in FIG. 4. The enumerated device paths of these additional crosstalk terms are denoted as SW:S1:A′:1:2 and SW:S1:D′:1:2.

Next, the network path is generated for each of the device paths. For illustration purposes, a first exemplary output signal 218 illustrates a most prominent crosstalk term originated from the first DEMUX 202. Since this crosstalk term arises from a previously generated crosstalk, its enumerated device path is concatenated with the device path of the previous crosstalk. One of the network paths of the crosstalk term at the output port 2 of the first switch 206 is denoted is as DEMUX:dm1:B:0:1-SW:S1:B:0:2.

In contrast, a second exemplary output signal 220 illustrates a most prominent crosstalk term that is not originated from the other device. The most prominent crosstalk term carried by the second output signal 220 is generated by the other input signal entering from the input port 0 of the first switch 206. Although the input signal is originating from the second DEMUX 202, the crosstalk term is generated at the first switch 206, and not at the second DEMUX 202. Accordingly, the network path for the most prominent crosstalk term of the second output signal 220 at the output port 3 of the first switch 206 is denoted as SW:S1:A:0:3.

The input port 0 of the first MUX 214 receives an input signal from the output port 2 of the first switch 206. The input signal at input port 0 is intended to carry channel A. The most prominent crosstalk term of this input signal is generated by channel B. This signal is then transmitted through the output port 4 of the first MUX 214. For illustration purposes, it is presumed that the first MUX 214 does not have any leaking currents from one channel to the other channels. The output signal and crosstalk levels are determined by the input-to-output port transfer function of the first MUX 214. At the output port 4 of the first MUX 214, the most prominent crosstalk term in the input signal is degraded by the loss of the multiplexer and appears as part of the output signal from the first MUX 214. The enumerated network path associated with the crosstalk term at the output port 4 is then represented as DEMUX:dmx1:B:0:1-SW:S1:B:0:2-MUX:mux1:B:0:4.

Similarly, the input port 0 of the second MUX 216 receives input from the output port 3 of the first switch 206 with the signal carrying the intended channel A′ and the most prominent crosstalk term generated by channel D′. This signal is then transmitted through the output port 4 of the second MUX 216. For illustration purposes, the second MUX 216 is also presumed not to have any leaking currents from one channel to the other channels. The network path associated with the crosstalk term at the output port 4 of the second MUX 216 is then represented as SW:S1:A:0:3-MUX:mux2:A:0:4.

The present invention provides an efficient method for identifying and tracking the sources of the most severe crosstalk terms and their routes in the network by enumerating crosstalk paths. By applying the tracking methods illustrated above, the most prominent crosstalk terms are identified with their traversal path through the system. Then crosstalk level of the system can be reduced or adjusted by modifying characteristics of one or more particular crosstalk generating devices, i.e., by modifying the filter transfer function of the particular device. This provides an efficient method for controlling and improving crosstalk performance of multiwavelength networks. With conventional simulation methods, in contrast, a complete time-domain analysis is computationally not generally feasible for large optical networks. Thus, the time-domain analysis is limited mainly to point-to-point WDM network subsystems. The present invention alleviates the complexity associated with the conventional approach. More specifically, the present invention enables the detailed time-domain analysis to be performed along enumerated paths incorporating all necessary system and device parameters to estimate the worst system performance. By identifying a predetermined number of worst paths in the optical network, one can simulate the degraded network performance. Therefore, the present invention makes possible a quicker and more extensive detection of significant network impairments, and aids network service providers to maintain a proper level of QoS in metro networks.

For illustration purposes, the present invention is described in the context of two and three-stage optical network elements. However, it should be understood that the present invention may be applied to any large multiwavelength optical networks having multi-stage network components. In addition, it will be apparent to those skilled in the art that various modifications and adaptations can be made to the present invention without departing from the spirit and scope of the invention. Thus, it is intended that the present invention covers the modifications and adaptations of this invention, provided they come within the scope of the appended claims and their equivalents.

What is claimed is:

1. A method for monitoring crosstalk in an optical network having a plurality of optical devices, comprising:
determining crosstalk at a first optical device in the optical network, wherein the crosstalk is expressed by a plurality of crosstalk terms;
identifying a prominent crosstalk term from the plurality of crosstalk terms associated with the first optical device;
determining crosstalk at a second optical device in the optical network, wherein the crosstalk is expressed by a plurality of crosstalk terms and the second optical device receives at least one signal channel from the first optical device;
identifying a prominent crosstalk term from the plurality of crosstalk terms associated with the second optical device; and
enumerating a network path which exhibits traversal of the crosstalk in the optical network, when the prominent crosstalk term associated with the second optical device relates to the prominent crosstalk term from the first optical device.

2. The method of claim 1 wherein the plurality of crosstalk terms associated with the second optical device includes the prominent crosstalk terms from the first optical device and other crosstalk terms occurring within the second optical device.

3. The method of claim 1 wherein the second optical device is a non-crosstalk generating device.

4. The method of claim 1 wherein the step of determining crosstalk at a first optical device further includes the steps of:
calculating a crosstalk level for each of the plurality of crosstalk terms associated with the first optical device; and
identifying a device path for each of the plurality of crosstalk terms associated with the first optical device.

5. The method of claim 4 wherein the step of identifying the prominent crosstalk term from the plurality of crosstalk terms associated with the first optical device further comprising the steps of:
sorting the crosstalk terms based on the crosstalk level for each of the plurality of crosstalk terms; and
selecting one or more prominent crosstalk terms associated with the first optical device, wherein the prominent crosstalk term of the first optical device has a strongest crosstalk level.

6. The method of claim 4 wherein the device path is denoted by one or more items selected from the group consisting of an input port from which the crosstalk enters a given optical device, an output port from which the crosstalk exits the given optical device, an address for the given optical device, a type for the given optical device, and a channel generating the crosstalk within the given optical device.

7. The method of claim 4 wherein the step of calculating a crosstalk level for each of the plurality of crosstalk terms further comprises using a port-to-port transfer function to determine the crosstalk level.

8. The method of claim 4 wherein the step of enumerating a network path further comprises concatenating a device path for the first optical device with a device path for the second optical device.

9. The method of claim 1 further comprising the steps of:
determining crosstalk at a third optical device in the optical network, wherein the crosstalk is expressed by a plurality of crosstalk terms and the third optical device receives at least one signal channel from the second optical device; and
identifying a prominent crosstalk term from the plurality of crosstalk terms associated with the third optical device.

10. The method of claim 9 wherein the step of enumerating a network path further comprises enumerating the network path when the prominent crosstalk term associated with the second optical device relates to either the prominent crosstalk term from the first optical device or the prominent crosstalk term from the third optical device.

11. A method for monitoring crosstalk in an optical network having a plurality of optical devices, comprising the steps of:
providing a first optical device in the optical network that receives a plurality of input signal channels, the first optical device having at least one output port;
determining crosstalk occurring at the at least one output port of the first optical device, wherein the crosstalk is generated from the plurality of input signal channels and is represented by a plurality of crosstalk terms;
identifying a most prominent crosstalk term from the plurality of crosstalk terms associated with the at least one output port of the first optical device;
providing a second optical device in the optical network that receives at least one signal channel from the at least one output port of the first optical device, the second optical device having at least one output port;
determining crosstalk occurring at the at least one output port of the second optical device, where the crosstalk is expressed by a plurality of crosstalk terms;
identifying a most prominent crosstalk term from the plurality of crosstalk terms associated with the at least one output port of the second optical device; and
enumerating a network path which exhibits traversal of crosstalk in the optical network, when the prominent crosstalk term associated with the at least one output port of the second optical device is related to the prominent crosstalk term from the at least one output port of the first optical device.

12. The method of claim 11 wherein the second optical device further includes a second output port and further comprising the steps of:
determining crosstalk occurring at the second output port of the second optical device, where the crosstalk is expressed by a plurality of crosstalk terms;
identifying a most prominent crosstalk term from the plurality of crosstalk terms associated with the second output port of the second optical device; and
enumerating a second network path which exhibits traversal of crosstalk in the optical network, wherein the prominent crosstalk term associated with the second output port of the second optical device is related to the prominent crosstalk term associated with the at least one output port of the first optical device.

13. The method of claim 11 further comprises the steps of:
providing a third optical device in the optical network that receives a plurality of second input signal channels, the third optical device having at least one output port;
determining crosstalk occurring at the at least one output port of the third optical device, wherein the crosstalk is generated from the plurality of second input signal channels and is represented by a plurality of crosstalk terms; and
identifying a most prominent crosstalk term from the plurality of crosstalk terms associated with the at least one output port of the third optical device.

14. The method of claim 13 wherein the step of enumerating a network path further comprises enumerating the network path when the prominent crosstalk term associated with the at least one output port of the second optical device relates to either the prominent crosstalk term from the at least one output port of the first optical device or the at least one output port of the third optical device.

15. The method of claim 11 wherein the step of determining crosstalk at a first optical device further includes the steps of:
calculating a crosstalk level for each of the plurality of crosstalk terms associated with the first optical device; and
identifying a device path for each of the plurality of crosstalk terms associated with the first optical device.

16. The method of claim 15 wherein the step of identifying the prominent crosstalk term from the plurality of crosstalk terms associated with the first optical device further comprising the steps of:
sorting the crosstalk terms based on the crosstalk level for each of the plurality of crosstalk terms; and
selecting one or more prominent crosstalk terms associated with the first optical device, wherein the prominent crosstalk term of the first optical device has a strongest crosstalk level.

17. The method of claim 15 wherein the device path is denoted by one or more items selected from the group consisting of an input port from which the crosstalk enters a given optical device, an output port from which the crosstalk exits the given optical device, an address for the given optical device, a type for the given optical device, and a channel generating the crosstalk within the given optical device.

18. The method of claim 15 wherein the step of calculating a crosstalk level for each of the plurality of crosstalk terms further comprises using a port-to-port transfer function to determine the crosstalk level.

19. The method of claim 15 wherein the step of enumerating a network path further comprises concatenating a device path for the first optical device with a device path for the second optical device.

20. A method for monitoring crosstalk in an optical network having an optical device, the method comprising the steps of:
determining crosstalk terms at a first output port, of an optical device receiving at least one input signal from a previous optical device and having a first output port, a second output port, and a third output port wherein the crosstalk is expressed by a plurality of crosstalk terms;
enumerating a device path for each of the crosstalk terms associated with the first output port;
identifying one or more prominent crosstalk terms associated with the first output port;
enumerating a network path which exhibits traversal of the crosstalk in the optical network, when the prominent crosstalk at the first output port of the optical device is originated from the previous device; and
repeating the steps (2)-(5) for the second and third output ports of the device, and for other devices present in the network, so as to monitor crosstalk in the optical network.

21. A method for monitoring crosstalk in an optical network having multiple optical devices, the method comprising the steps of:
calculating and recording the values of at least the most significant crosstalk terms generated within an optical device and through the network associated with each of said terms; and
calculating and recording the values of at least the most significant output crosstalk terms resulting at the output of an other optical device in the network that receives optical communications signals from the said optical device, the output crosstalk terms including crosstalk terms generated within the said optical device, and enumerating a path through the network associated with each of said output terms.
